(19) United States
(12) Patent Application Publication
(10) Pub. No.: US 2021/0307877 A1
(43) Pub. Date: Oct. 7, 2021

(54) LINGUAL RETAINER

(71) Applicant: Hirsch Dynamics Holding AG, Wollerau (CH)

(72) Inventor: Markus HIRSCH, Wollerau (CH)

(73) Assignee: Hirsch Dynamics Holding AG, Wollerau (CH)

(21) Appl. No.: 17/350,229

(22) Filed: Jun. 17, 2021

Related U.S. Application Data
(63) Continuation of application No. PCT/EP2019/086444, filed on Dec. 19, 2019.
Application No. PCT/EP2019/086444 is a continuation-in-part of application No. 16/227,102, filed on Dec. 20, 2018.
Application No. 16/227,102 is a continuation of application No. 16/562,575, filed on Sep. 6, 2019.
Application No. 16/562,575 is a continuation of application No. 16/227,102, filed on Dec. 20, 2018.
Application No. 16/227,102 is a continuation of application No. 16/562,575, filed on Sep. 6, 2019.
Application No. 16/562,575 is a continuation-in-part of application No. 16/227,102, filed on Dec. 20, 2018.

(51) Int. Cl. A61C 7/08; A61C 7/00

(52) U.S. Cl. CPC A61C 7/08; B33Y 50/00; A61C 7/002

(57) ABSTRACT

An orthodontic retainer is configured for application to a lingual surface of a patient's teeth. The retainer is custom designed to exactly match the shape of the lingual side of the patient's teeth and is formed from a plurality of tooth-adhering portions connected by elongated connection portions. The tooth-adhering portions each have a generally flat top edge and a generally curved bottom edge. The connection portions are located at a position below the top edge and above the bottom edge of the tooth-adhering portions. The retainer is formed as a single piece by milling, injection molding or 3D printing.

### BACKGROUND OF THE INVENTION

### 1. Field of the Invention

This invention relates to an orthodontic retainer to maintain teeth in a treated position after orthodontic treatment has been completed. In particular, the invention relates to a fully aesthetic ceramic lingual retainer that is attached on the lingual face of the teeth, so that the retainer cannot be seen.

### 2. The Prior Art

Orthodontic retainers are used to maintain teeth in a finished position after orthodontic treatment is completed. The retainers can be fixed or removable. An orthodontic retainer can be made in many forms. Some retainers are positioned on the lingual side of the teeth and permanently fixed in place. The traditional lingual retainers are formed by brackets that are cemented to the back of the teeth and then connected by a wire. These retainers have the advantage that they cannot be seen, and do not have to be removed while eating. However, they have several disadvantages. One problem with fixed lingual retainers is that they can be bulky, leading to discomfort and even affect the user's speech. In addition, they make it very difficult to clean between the teeth, and around the retainer brackets, increasing the possibility of tooth decay.

### SUMMARY OF THE INVENTION

It is therefore an object of the invention to provide a fully aesthetic lingual retainer that avoids the disadvantages listed above and which is comfortable, does not affect speech, and enables thorough cleaning between teeth and around the retainer.

These and other objects are accomplished by an orthodontic retainer configured for application to a lingual surface of a patient's teeth, comprising a plurality of tooth-adhering portions connected by elongated connection portions, the tooth-adhering portions each having a generally flat top edge and a generally curved bottom edge and having a joining side configured to match a curvature of a corresponding tooth of the patient. The connection portions are located at a position below the top edge of the tooth-adhering portions. The tooth-adhering portions and connection portions are formed as a single piece with each other. The tooth-adhering portions preferably cover about 30-80% of the surface area of the patient's teeth, with the connection portions being formed narrower, to expose as much tooth surface as possible between the tooth-adhering portions.

Preferably, the retainer is formed of ceramic, composite, or metal. In a particularly preferred embodiment, the retainer is translucent, opaque or fully transparent ceramic or composite material. Preferred materials are aluminum oxide or zirconium oxide ceramics.

In order to make the retainer as comfortable as possible, the retainer is formed to be very thin. In particular, the retainer can be made to be between 0.3 and 1.5 mm thick, and is preferably about 0.8 mm thick.

The retainer can be formed using any suitable fabrication methods. In particular, the retainer can be made by any suitable method, such as CNC milling, injection molding, 3D printing (metal composite, ceramic), composite vacuum forming or any type of additive technology. For all of these methods, a model of the retainer is made based on the shape of the lingual side of the patient's teeth, and sized so that the retainer covers only a pre-set percentage of the tooth area. The retainer can be trimmed to size or molded, milled or printed into the exact size.

In one embodiment, the retainer is equipped with openings in each tooth-adhering portion, to able to place the glue directly onto each individual tooth and to ventilate air and glue residues. The openings can be cut into the fully formed retainer or the retainer can be manufactured with the openings already formed.

In another embodiment, the lingual retainer is divided into two halves, one on each of the left and right sides of the mouth. This two-piece arrangement allows for the natural bone movement along the median palatine suture. This retainer can be made by manufacturing the retainer in two pieces, or by cutting a single piece retainer in half and trimming the cut connection portions.

The retainer can be manufactured with a light-curable adhesive already placed on the tooth-adhering portions, so that no additional glue will be needed by the doctor to place the retainer. The light curing takes place after the retainer is affixed to the patient's teeth. The retainer is delivered to the doctor in special packaging so that the adhesive is not activated prior to placement on the teeth.

The retainer is intended for use after a full treatment with traditional braces or aligners to straighten the patient's teeth. The retainer of the present invention is meant to keep the teeth in the finished position over long periods of time, e.g., 2 months, 1 year, 2 years, or an entire lifetime. The retainer can be used on both the upper and lower sets of teeth, and is adhered to the teeth using standard dental adhesives. The retainer is a fully aesthetic retainer that cannot be seen when in use. It is simple to produce, comfortable to wear, and aesthetically pleasing as it is essentially invisible to others.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a front view of the retainer according to the invention;

FIG. 2 shows a view of the retainer attached on the lingual side of a patient's teeth;

FIG. 3 shows a cross-sectional view of a tooth on which the lingual retainer is adhered; and

FIG. 4 shows an alternative embodiment of the invention, with the lingual retainer being applied using a placement jig;

FIG. 5 shows an alternative embodiment of the lingual retainer;

FIG. 6 shows another alternative embodiment of the lingual retainer; and

FIG. 7 shows the method steps for manufacturing the retainer according the invention.

### DETAILED DESCRIPTION OF THE PREFERRED EMBODIMENT

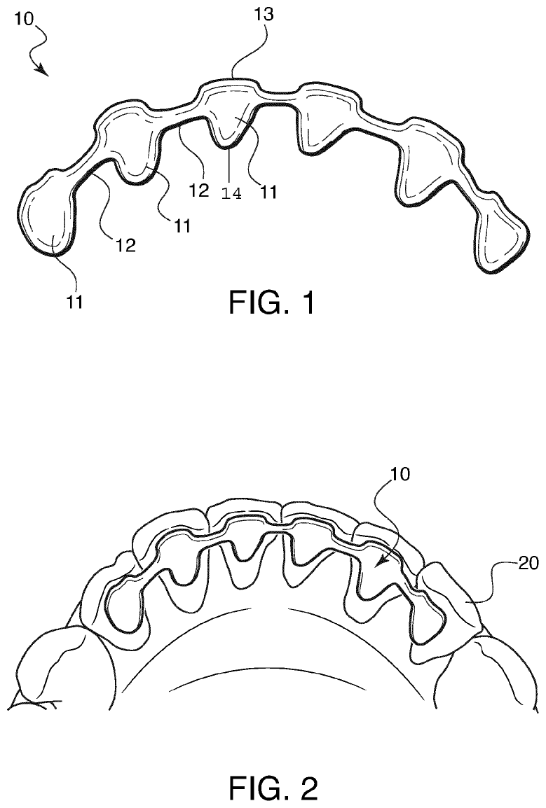

Referring now in detail to the drawings, FIG. 1 shows a front view of the retainer 10 according to the invention. Retainer 10 comprises a plurality of tooth-adhering portions 11 connected by elongated connection portions 12. Each of the tooth-adhering portions 11 has a generally flat top edge 13 and a generally curved bottom edge 14. The connection portions 12 are located at a position below the top edge 13 of the tooth-adhering portions 11. The tooth-adhering portions 11 and connection portions 12 are formed as a single piece hydride solution, or in several pieces in a single manufacturing process.

FIG. 2 shows the retainer 10 connected to the patient's teeth 20. Retainer 10 has a rear surface that corresponds to the rear (lingual) side 21 of each of the patient's teeth 20 so that it fits securely onto the teeth. The retainer 10 can be bonded to the teeth 20 using any conventional dental bonding material.

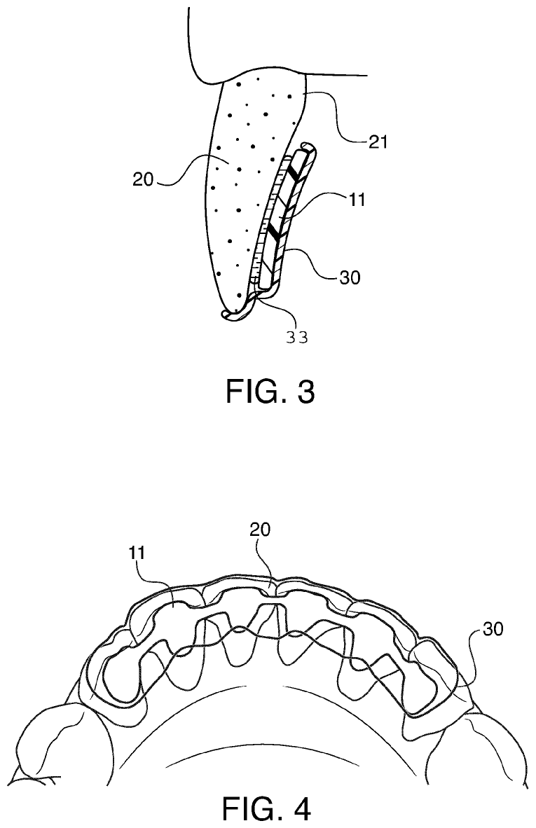

FIG. 3 shows a side view of a tooth 20 to which tooth-adhering portion 11 is attached using an adhesive 33. As can be seen in FIG. 3, the shape of tooth-adhering portion 11 closely follows the shape of the lingual side 21 of the patient's tooth 20. A placement jig 30 can be used to exactly position the retainer 10 on the patient's teeth 20. Jig 30 is formed in the shape of the patient's teeth 20 and fits exactly over the teeth 20. The retainer 10 is fitted into the jig 30, which is then placed over the teeth 20 and allowed to stay on the teeth 20 while the adhesive 33 of the retainer 10 cures, as shown in FIG. 4. The jig 30 can be manufactured using the same scan of the patient's teeth 20 that is used for form the retainer 10. The jig 30 can be made using any conventional processes, such as thermoforming.

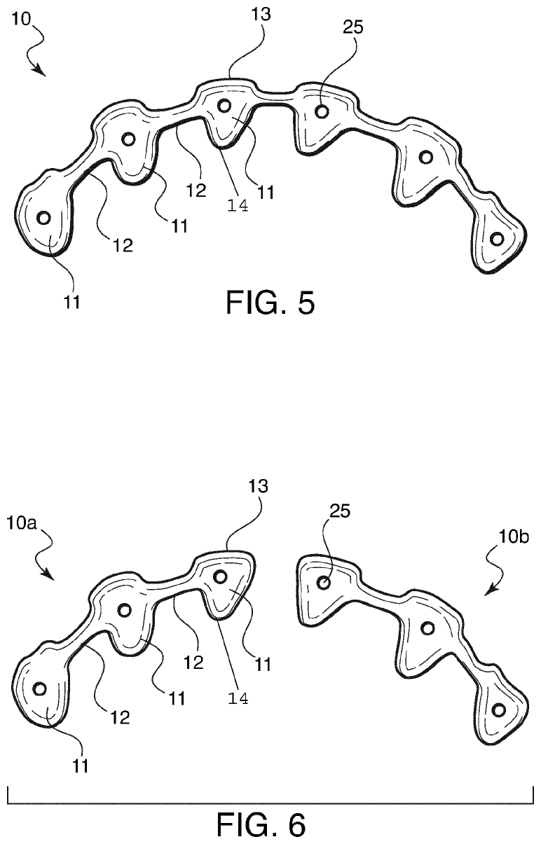

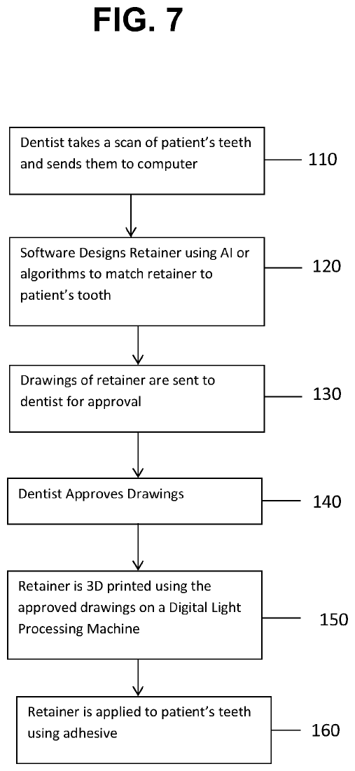

FIGS. 5 and 6 show alternative embodiments of the lingual retainer 10 according to the invention. FIG. 5 shows retainer 10 wherein each tooth-adhering portion 11 has a hole 25 therethrough. Holes 25 allow the technician to place the adhesive 33 directly onto each tooth 20, then apply the retainer 10. Holes 25 allow for ventilation of air and evaporation of any adhesive 33 residues. As shown in FIG. 6, the retainer 10 can be formed of two separate pieces 10a and 10b, which are then mounted one on each side of the median palatine suture. These pieces 10a, 10b can be equipped with or without holes 25. Making the retainer 10 in two separate pieces 10a, 10b, allows for natural bone movement along the median palatine suture, as there is no retainer spanning it.

The present invention also applies for a method for manufacturing the lingual retainer 10. In a first step 110, a scan is made of the patient's teeth after correction with the desired orthodontic treatment. This scan is then fed into a computer having software that designs the retainer for manufacture by any desired method in step 120. The software can use artificial intelligence or other algorithms to design the lingual retainer from the scans. In step 130, drawings of the proposed retainer are then sent to the doctor for a final check. If approved in step 140, the lingual retainer 10 is manufactured in step 150 according to the scan using any desired method such as 3D printing, CIM (ceramic injection molding) or CNC milling, preferably from ceramic materials such as aluminum oxide or zirconium oxide. Preferably, the manufacturing is done using 3D printing with a DLP (digital light processing) printer. Finally, in step 160, the retainer is applied to a patient's teeth using adhesive.

Holes 25 can then be drilled in the tooth-adhering portions if desired. The retainer can be manufactured in a single piece or as two separate pieces. If manufactured as a single piece, the retainer can be cut in half if a two-piece design is required.

The retainer according to the invention can be quickly and easily manufactured, and increases patient comfort due to its low profile. It can be manufactured using a transparent or translucent ceramic or composite material, so it is virtually invisible, even from the rear. The retainer allows for simple and effective cleaning of the teeth because the small width of the connection portions leaves plenty of room for brushes and floss to clean and floss the teeth.

Accordingly, while only a few embodiments of the present invention have been shown and described, it is obvious that many changes and modifications may be made thereunto without departing from the spirit and scope of the invention.

1. An orthodontic retainer (10) configured for application to a lingual surface of a patient's teeth (20), comprising:
a plurality of tooth-adhering portions (11) connected by elongated connection portions (12), the tooth-adhering portions (11) each having a generally flat top edge (13) and a generally curved bottom edge (14) and having a joining side configured to match a curvature of a corresponding tooth (20) of the patient, the connection portions (12) being located at a position below the top edge (13) of the tooth-adhering portions (11), wherein the tooth-adhering portions (11) and connection portions (12) are formed as a single piece.

2. The orthodontic retainer (10) according to claim 1, wherein the retainer (10) is formed a material selected from the group consisting of ceramic, plastic resin and metal.

3. The orthodontic retainer (10) according to claim 2, wherein the retainer (10) is translucent.

4. The orthodontic retainer (10) according to claim 1, wherein the retainer (10) is between 0.3 and 1.5 mm thick.

5. The orthodontic retainer (10) according to claim 1, wherein each tooth adhering portion (11) has a hole (25) therethrough.

6. The orthodontic retainer (10) according to claim 1, wherein a layer of light-curable adhesive (33) is disposed on a surface of each of the tooth-adhering portions (11).

7. The orthodontic retainer (10) according to claim 1, wherein the retainer (10) is formed of two separate pieces (10a, 10b), each piece (10a, 10b) comprising one half of the number of tooth adhering portions (11) linked by the connection portions (12) in the orthodontic retainer (10).

8. A method for manufacturing an orthodontic retainer (10), comprising:
creating a model or scan of at least a lingual side (21) of a patient's teeth (20),
manufacturing a dental retainer (10) having a front side and a rear side, the rear side being formed to match a shape of the lingual side (21) of the patient's teeth (20), the dental retainer (10) being formed of tooth-adhering portions (11) connected by connection portions (12) that are narrower than the tooth adhering portions (11); and
adhering the retainer (10) to the patients teeth (20) using an adhesive (33), so that the each tooth-adhering portion (11) is connected to a separate one of the teeth (20).

9. The method according to claim 8, wherein the step of manufacturing is selected from the group consisting of CNC milling, injection molding and 3D printing, composite vacuum forming and additive technology.

10. The method according to claim 8, further comprising placing the retainer (10) in a jig (30) that is formed to correspond to the patients teeth (20), and placing the jig (30) on the patient's teeth (20) so that the retainer (10) is positioned on the lingual side (21) of the patient's teeth (20), and removing the jig (30) after the adhesive (33) is cured.

11. The method according to claim 8, further comprising forming a hole (25) in each of the tooth-adhering portions (11).

12. The method according to claim 8, wherein the dental retainer (10) is manufactured in two separate pieces (10a, 10b), and each piece (10a, 10b) is adhered separately to the patient's teeth (20).

13. The method according to claim 8, wherein the dental retainer (10) is manufactured in a single piece and then cut in half.
